(19) United States
(12) Patent Application Publication
(10) Pub. No.: US 2013/0163439 A1
(43) Pub. Date: Jun. 27, 2013

(54) METHOD, DEVICE AND SYSTEMFOR SENDING AND RECEIVING INTERFACE CONNECTIVITY INFORMATION

(71) Applicants: Beibei Jia, Beijing (CN); Dajun Zhang, Beijing (CN); Yi Yang, Beijing (CN); Wei Bao, Beijing (CN)

(72) Inventors: Beibei Jia, Beijing (CN); Dajun Zhang, Beijing (CN); Yi Yang, Beijing (CN); Wei Bao, Beijing (CN)

(21) Appl. No.: 13/691,746

(22) Filed: Dec. 1, 2012

Related U.S. Application Data
(63) Continuation of application No. PCT/CN2011/078304, filed on Aug. 11, 2011.

(30) Foreign Application Priority Data
Aug. 12, 2010 (CN) 201010251893.9

(51) Int. Cl. H04W 92/16

(52) U.S. Cl. CPC H04W 92/16
USPC 370/242; 370/328; 370/254

(57) ABSTRACT

The invention discloses a method and device for sending and receiving interface connectivity information. eNB sends the message carrying interface connectivity information between eNB and neighbor eNB through X2 interface to enable relay node to acquire the interface connectivity information between eNB and neighbor eNB to further accomplish handover, automatic neighbor relation setup, interference coordination and load equilibrium.

### CROSS REFERENCE TO RELATED APPLICATIONS

This application is a continuation of PCT/CN2011/078304 filed on Aug. 11, 2011, which claims priority to Chinese Patent Application No. 201010251893.9 filed in the Patent Office of the People's Republic of China on Aug. 12, 2010, entitled “Method, Device and System for Sending and Receiving Interface Connectivity Information” the disclosures of which are hereby incorporated by reference in their entireties.

### FIELD OF THE INVENTION

The present invention relates to communication field, in particular to a method and device for sending and receiving interface connectivity information.

### BACKGROUND OF THE INVENTION

The cost of eNB is often high. In development of 3G (3rd-generation) technology, construction of a great number of eNBs will arouse higher deployment cost. To reduce the cost, relay is gradually introduced into honeycomb system to increase the coverage of eNB signal. FIG. 1a shows the network frame of LTE-A (LTE-Advanced) system after introducing RN (Relay Node). RN is accessed into corenet through donor cell below DeNB (Donor Evolved Node B) and no direct wired interface is provided between RN and corenet. Each RN can control one or several cells. Under this frame, interface between UE (User Equipment) and RN is called Uu interface and that between RN and DeNB is called Un interface. Several RN can be connected to a DeNB while an RN can only be connected to a DeNB.

FIG. 1b shows the structural diagram of LTE-A system after introducing RN. S1 interface is connected to node eNB in E-UTRAN (Evolved UTRAN) at one side and to node MME/S-GW (Mobility Management Entity/ Serving Gateway) in EPC (Evolved Packet Core) at the other side, or connected to eNB at one side and to RN at the other side. X2 interface is located between node eNBs in E-UTRAN or between eNB and RN. X2 interface of many-to-many relationship is provided between eNBs and X2 connection may be provided among all eNodeBs within a certain area. The major purpose for existence of X2 interface lies in supporting mobility management function of UE in connection state. Besides, the main function of X2 interface comprises load management function, cell interference coordination function, common X2 management function and error control function.

In LTE (Long Term Evolution) system, when an eNB requires X2 interface application configuration, such as to increase/decrease or modify cell configuration, it is necessary to update eNB configuration, as shown in FIG. 2. eNB1 sends eNB configuration update message to eNB2, including the added/decreased cell PCI (Physical Cell Identifier), ECGI (E-UTRAN Cell Global Identifier, E-UTRAN), frequency and other information. If eNB2 can accept the updating, eNB1 configuration information stored itself will be updated and eNB configuration update acknowledge message will be returned to eNB1. Every cell has the only ID ECGI that is 52 bit and composed of PLMN (Public Land Mobile Network) ID, eNB ID and cell ID. Wherein, PLMN ID and eNB ID constitute the only ID global eNB ID of eNB which is 44 bit in total, and cell ID is the remaining 8 bit. At present, ECGI of cell is generally distributed by OAM (Operation Administration and Maintenance).

In LTE system at present, eNB can only acquire interface connectivity information of neighbor eNB through X2 connection setup process or eNB configuration update process, including which cells neighbor eNB manages and the ID, frequency and other information of those cells. After introducing RN, RN and DeNB only have an X2 interface and an S1 interface since DeNB has S1/X2 AP agent function, viz. RN can only acquire information of cell managed by DeNB through said X2 connection setup process or eNB configuration update process. However, RN requires acquiring interface connectivity information of DeNB and other eNB during handover, ANR (Automatic Neighbor Relation), interference coordination and load equilibrium. To settle the problem, a new mechanism for acquiring interface connectivity is required.

### SUMMARY OF THE INVENTION

The embodiments of the present invention provide a method and device for sending and receiving interface connectivity information to enable RN to acquire interface connectivity information of DeNB and other eNBs.

The embodiments of the present invention provide a method for receiving interface connectivity information, including:

Receive the message sent by eNB through X2 interface;

Acquire interface connectivity information between said eNB and neighbor eNB carried in said message.

The embodiments of the present invention provide a method for sending interface connectivity information, including:

eNB sends message through X2 interface, and such message carries interface connectivity information between said eNB and neighbor eNB.

The embodiments of the present invention provide a kind of network devices, including:

Receiving unit, which is used to receive the message sent by eNB through X2 interface;

Acquisition unit, which is used to acquire interface connectivity information between said eNB and neighbor eNB carried in said message.

The embodiments of the present invention provide an eNB, including:

Sending unit, which is used to send message through X2 interface, and such message carries interface connectivity information between said eNB and neighbor eNB.

The embodiments of the present invention provide a network system, including:

eNB, which is used to send message through X2 interface, and such message carries interface connectivity information between said eNB and neighbor eNB.

Relay node (RN), which is used to receive the message sent by eNB through X2 interface and acquire interface connectivity information between said eNB and neighbor eNB carried in said message.

Compared with the present technology, the embodiments of the present invention at least possess the following advantages:

eNB sends the message carrying interface connectivity information between eNB and neighbor eNB through X2 interface to enable relay node to acquire the interface connectivity information between eNB and neighbor eNB to further accomplish handover, automatic neighbor relation setup, interference coordination and load equilibrium.

### BRIEF DESCRIPTION OF THE DRAWINGS

To further clearly explain the technical proposal in the embodiments of the present invention or present technology, attached drawings required in the embodiments of the present invention or present technology description shall be simply introduced below. Obviously, drawings described below are only some embodiments of the present invention, and for ordinary technicians of this field, they can also acquire other attached drawings based on these drawings on the premise of paying no creative work.

FIG. 1a is a network architecture diagram of LTE-A system after introducing RN in present technology;

FIG. 1b is a structural diagram of LTE-A system after introducing RN in present technology;

FIG. 2 is a schematic diagram of eNB configuration update process in present technology;

FIG. 3 is a schematic diagram of method for receiving interface connectivity information provided in Embodiment I of the present invention;

FIG. 4 is a schematic diagram of method for receiving interface connectivity information provided in Embodiment III of the present invention;

FIG. 5 is a schematic diagram of method for receiving interface connectivity information provided in Embodiment IV of the present invention;

FIG. 6 is a schematic diagram of method for receiving interface connectivity information provided in Embodiment V of the present invention;

FIG. 7 is a schematic diagram of method for receiving interface connectivity information provided in Embodiment VI of the present invention;

FIG. 8-11 is a structural diagram of network device provided in Embodiment VII of the present invention;

FIG. 12 is a structural diagram of eNB provided in Embodiment VIII of the present invention.

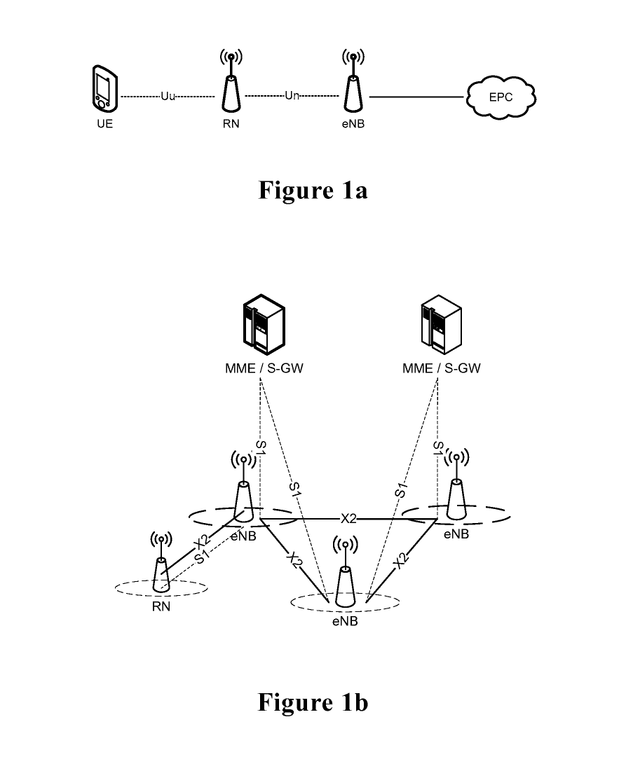

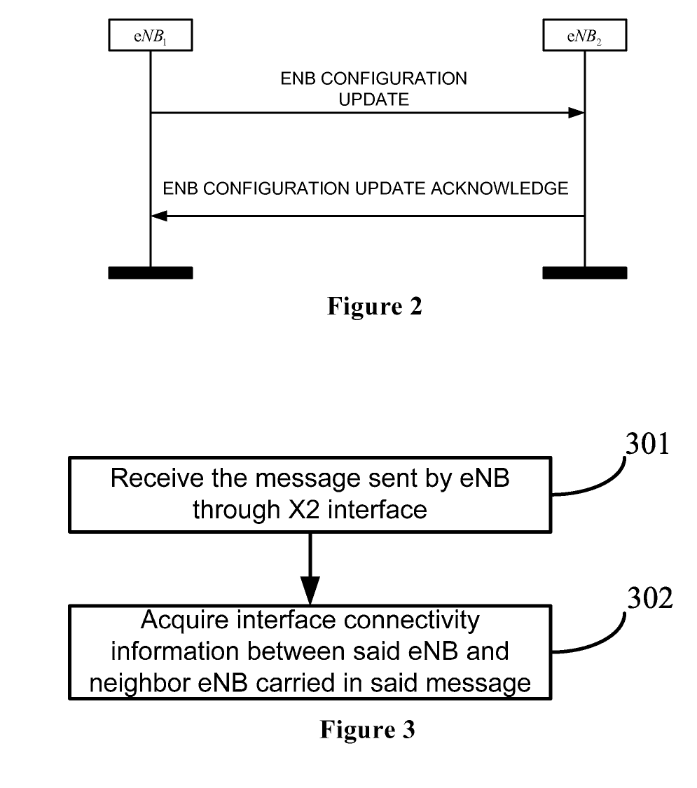

### DETAILED DESCRIPTION OF PREFERRED EMBODIMENTS

Then we will clearly and completely describe the technical proposals in the embodiments of the present invention in combination of the attached drawings therein. Obviously, the embodiments described below are only a part of the embodiments of the present invention instead of the whole. Based on the embodiments of the present invention, other embodiments acquired by ordinary technicians of this field on the premise of paying no creative work all belong to the protected scope of the embodiments of the present invention.

### Embodiment I

Embodiment I of the present invention provides a method for receiving interface connectivity information, as shown in FIG. 3, including:

Step 301, receive message sent by eNB through X2 interface;

Step 302, acquire interface connectivity information between side eNB and neighbor eNB carried in said message.

Said message is specifically eNB configuration update message.

Before step 302, it also includes:

Acquire serving cell information carried in configuration update message of said eNB, and judge that configuration update message of said eNB carries configuration information of neighbor eNB of said eNB or configuration information of said eNB according to serving cell information; or

When configuration update message of said eNB carries global eNB ID IE, judge that configuration update message of said eNB carries configuration information of neighbor eNB of said eNB, otherwise, judge that configuration update message of said eNB carries configuration information of said eNB ; or

Acquire global eNB ID IE carried in configuration update message of said eNB, and judge that configuration update message of said eNB carries configuration information of neighbor eNB of said eNB or configuration information of said eNB according to global eNB ID IE.

Said message also can be indirect eNB configuration update message specifically. At that time before step 301, it also includes sending indirect eNB configuration update request message to said eNB.

Said interface connectivity information contains the following one or several kinds of information: ID of neighbor eNB having X2 interface with said eNB; serving cell configuration information of said neighbor eNB; serving cell configuration information added by said neighbor eNB; serving cell configuration information modified by said neighbor eNB; serving cell configuration information deleted by said neighbor eNB; neighbor cell configuration information of serving cell of said neighbor eNB; MME POOL information of said neighbor eNB; energy-saving status of serving cell of said neighbor eNB.

After step 302, it also includes sending handover request to eNB, acquiring failure reason carried thereof after receiving handover preparation failure message sent by said eNB, indicating nonexistence of X2 interface according to said failure reason and updating interface connectivity information between said eNB and neighbor eNB stored.

### Embodiment II

Embodiment II of the present invention provides a method for sending interface connectivity information, eNB sends message through X2 interface and the message carries the interface connectivity information between said eNB and neighbor eNB.

Wherein, said message is specifically eNB configuration update message. Said eNB configuration update message distinguishes the carried configuration information is that of neighbor eNB of said eNB or that of said eNB through the carried serving cell information, or said eNB configuration update message distinguishes the carried configuration information is that of neighbor eNB of said eNB or that of said eNB through whether it is carried with global eNB ID IE, or said eNB configuration update message distinguishes the carried configuration information is that of neighbor eNB of said eNB or that of said eNB through the carried global eNB ID IE.

Said message also can be indirect eNB configuration update information specifically.

Said interface connectivity information contains the following one or several kinds of information: ID of neighbor eNB having X2 interface with said eNB; serving cell configuration information of said neighbor eNB; serving cell configuration information added by said neighbor eNB; serving cell configuration information modified by said neighbor eNB; serving cell configuration information deleted by said neighbor eNB; neighbor cell configuration information of serving cell of said neighbor eNB; MME POOL information of said neighbor eNB; energy-saving status of serving cell of said neighbor eNB.

When handover request is received subsequently and the handover preparation fails due to nonexistence of X2 interface, it also includes: said eNB indicates X2 interface does not exist in failure reason carried in handover preparation failure message.

### Embodiment III

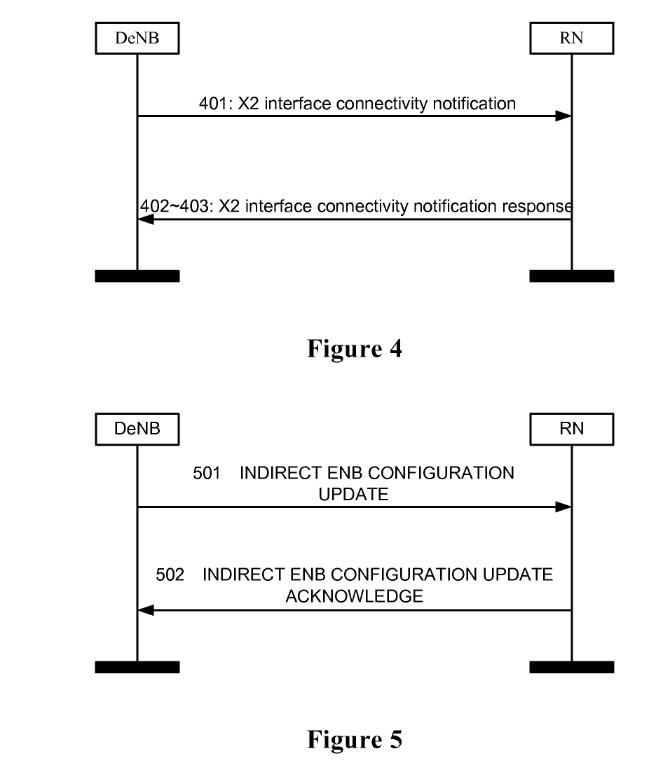

Embodiment III of the present invention provides a method for acquiring interface connectivity information. DeNB sends interface connectivity information of itself and neighbor eNB through X2 interface. In embodiments of the present invention, RN is taken as the example to introduce device connected to DeNB through X2 interface, as shown in FIG. 4. The method comprises the following steps specifically:

Step 401, DeNB sends X2-AP message to RN to initiate X2 interface connectivity notification process to be used for DeNB to notify X2 interface connectivity information of DeNB to RN.

Wherein, X2 interface connectivity information mainly includes: ID of neighbor eNB having X2 interface with DeNB; serving cell configuration information of said neighbor eNB; serving cell configuration information added by said neighbor eNB; serving cell configuration information modified by said neighbor eNB; serving cell configuration information deleted by said neighbor eNB (PCI, ECGI, frequency, etc.); neighbor cell configuration information of serving cell of neighbor eNB; energy-saving status of serving cell of neighbor eNB, MME POOL information of neighbor eNB. DeNB sends X2-AP message to RN in a periodic or incident-triggering manner. The way of incident triggering is to send X2-AP message to RN after adding and/or modifying and/or deleting cell configuration information or MME POOL information.

Step 402, RN receives X2 interface connectivity notification message, saves X2 interface connectivity information of DeNB and neighbor eNB and sends X2 interface connectivity notification acknowledge message to DeNB.

Step 403, DeNB receives X2 interface connectivity notification acknowledge message returned from RN and verifies X2 interface connectivity notification process is finished.

### Embodiment IV

In Embodiment IV of the present invention, it specifically defines X2-AP message in Embodiment III, as shown in FIG. 5. X2-AP message in Embodiment IV of the present invention is specifically indirect eNB configuration update message. The method specifically includes the following steps:

Step 501, DeNB sends indirect eNB configuration update message to RN to initiate X2 interface configuration update process to notify RN the configuration information of all other eNBs having X2 interface with DeNB.

Configuration information of all other eNBs having X2 interface with DeNB is namely eNB List IE, which comprises neighbor eNB ID, serving cell configuration information of said neighbor eNB; serving cell configuration information added by said neighbor eNB; serving cell configuration information modified by said neighbor eNB; serving cell configuration information deleted by said neighbor eNB (PCI, ECGI, frequency, etc.), neighbor cell configuration information serving cell of neighbor eNB , energy-saving status of serving cell of neighbor eNB , MME POOL information of neighbor eNB, viz. including X2 interface connectivity information of DeNB and neighbor eNB.

Step 502, RN acquires X2 interface connectivity information of DeNB and neighbor eNB, saves and updates configuration information of neighbor eNB, returns indirect eNB configuration update acknowledge message to DeNB and verifies the configuration update process is finished.

It is necessary to explain that before step 501, it also includes: RN sends indirect eNB configuration update request message to DeNB to request DeNB to notify RN the configuration information of neighbor eNB. The process is optional.

Wherein, format of INDIRECT ENB CONFIGURATION UPDATE message is shown in Table 1:

TABLE 1

| IE/Group | | | IE type and | | | Assigned |
|---|---|---|---|---|---|---|
| Name | Presence | Range | reference | Semantics description | Criticality | Criticality |
| Message | M | | 9.2.13 | | YES | Reject |
| Type | (Mandatory) | | | | | |
| eNB List | | 0 to max | | This list includes the | GLOBAL | Reject |
| | | eNBs | | eNBs having X2 | | |
| | | | | connection with the | | |
| | | | | DeNB | | |
| >Global | M | | 9.2.22 | | YES | Reject |
| eNB ID | (Mandatory) | | | | | |
| >Served | | 0 to | | | GLOBAL | Reject |
| cells To | | maxCelline | | | | |
| Add | | NB | | | | |
| >>Served | M | | 9.2.8 | | — | — |
| cell | (Mandatory) | | | | | |
| Information | | | | | | |
| >>Neighbour | | 0 to | | | — | — |
| Information | | maxnoofNeighbours | | | | |
| >>>ECGI | M | | ECGI | E-UTRAN Cell Global | — | — |
| | (Mandatory) | | 9.2.14 | Identifier of the | | |
| | | | | neighbour cell | | |
| >>>PCI | M | | INTEGER | Physical Cell Identifier | — | — |
| | (Mandatory) | | (0 . . . 503, . . . ) | of the neighbour cell | | |
| >>>EARFCN | M | | 9.2.26 | DL EARFCN for FDD | — | — |
| (E-UTRA | (Mandatory) | | | and EARFCN for TDD | | |
| Absolute | | | | | | |
| Radio | | | | | | |
| Frequency | | | | | | |
| Channel | | | | | | |
| Number, | | | | | | |
| E-UTRAN | | | | | | |
| >Served | | 0 to | | | GLOBAL | Reject |
| cells To | | maxCelline | | | | |
| Modify | | NB | | | | |
| >>Old | M | | ECGI | This is the old | — | — |
| ECGI | (Mandatory) | | 9.2.14 | E-UTRAN Cell Global | | |
| | | | | Identifier | | |
| >>Served | M | | 9.2.8 | | — | — |
| cell | (Mandatory) | | | | | |
| Information | | | | | | |
| >>Neighbour | | 0 to | | | — | — |
| Information | | maxnoofNeighbours | | | | |
| >>>ECGI | M | | ECGI | E-UTRAN Cell Global | — | — |
| | (Mandatory) | | 9.2.14 | Identifier of the | | |
| | | | | neighbour cell | | |
| >>>PCI | M | | INTEGER | Physical Cell Identifier | — | — |
| | (Mandatory) | | (0 . . . 503, . . . ) | of the neighbour cell | | |
| >>>EARFCN | M | | 9.2.26 | DL EARFCN for FDD | — | — |
| | (Mandatory) | | | and EARFCN for TDD | | |
| | | | | DL EARFCN for FDD | | |
| | | | | and EARFCN for TDD | | |
| >>Deactivation | O (Optional) | | ENUMERATED | Indicates the concerned | YES | Ignore |
| Indication | | | (deactivated, | cell is switched off for | | |
| | | | . . . ) | energy saving reasons | | |
| >Served | | 0 to | | | GLOBAL | Reject |
| cells To | | maxCelline | | | | |
| Delete | | NB | | | | |
| >>Old | M | | ECGI | This is the old | — | — |
| ECGI | (Mandatory) | | 9.2.14 | E-UTRAN Cell Global | | |
| | | | | Identifier of the cell to | | |
| | | | | be deleted | | |
| >GU | | 0 to | | | GLOBAL | Reject |
| Group Id | | maxPools | | | | |
| To Add | | | | | | |
| List | | | | | | |
| >>GU | M | | 9.2.20 | | — | — |
| Group Id | (Mandatory) | | | | | |
| >GU | | 0 to | | | GLOBAL | Reject |
| Group Id | | maxPools | | | | |
| To Delete | | | | | | |
| List | | | | | | |
| >>GU | M | | 9.2.20 | | — | — |
| Group Id | (Mandatory) | | | | | |

Format of INDIRECT ENB CONFIGURATION UPDATE ACKNOWLEDGE message is shown in Table 2:

TABLE 2

| | | | IE type | Seman- | | |
|---|---|---|---|---|---|---|
| IE/Group | Pres- | | and | tics des- | Criti- | Assigned |
| Name | ence | Range | reference | cription | cality | Criticality |
| Message | M | | 9.2.13 | | YES | Reject |
| Type | | | | | | |
| Criticality | O | | 9.2.7 | | YES | Ignore |
| Diagnostics | | | | | | |

### Embodiment V

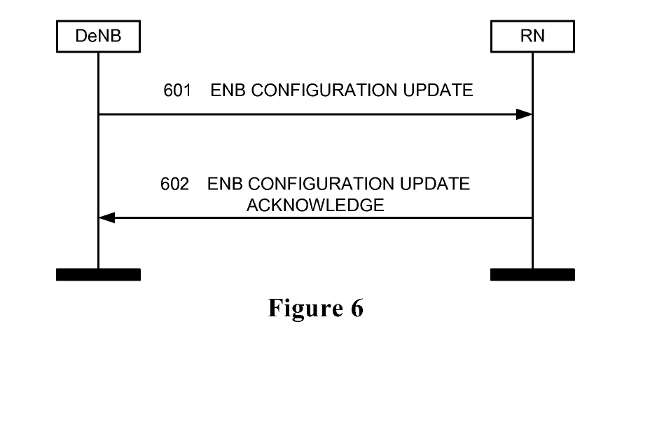

In Embodiment V of the present invention, it specifically defines X2-AP message in Embodiment III, as shown in FIG. 6. X2-AP message in Embodiment V of the present invention is specifically eNB configuration update message. The method specifically includes the following steps:

Step 601, DeNB sends eNB configuration update message that carries X2 interface connectivity information of DeNB and neighbor eNB to RN to initiate X2 interface configuration update process. Wherein, DeNB organizes the eNB configuration update message comprises all present neighbor eNB configuration information according to information of X2 interface setup process and eNB configuration update process from neighbor eNB.

Step 602, RN saves and updates X2 interface connectivity information of DeNB and neighbor eNB, returns eNB configuration update acknowledge message to DeNB to verify that configuration update process is finished.

Specifically, RN is required to judge the carried information thereof is configuration information of DeNB or that of DeNB neighbor eNB after receiving eNB configuration update message. The judging method includes any of the following three kinds:

a) If the former 44 bit (used to identify global eNB ID) in serving cell ECGI in eNB configuration update message received by RN is the same as the global eNB ID of RN itself, RN judges it is the configuration information of DeNB, or it is the configuration information of DeNB neighbor eNB;

b) If global eNB ID IE is not carried in eNB configuration update message, RN judges it is the configuration information of DeNB; if global eNB ID IE is carried, RN judges the eNB configuration update process is used for transmitting configuration information of DeNB neighbor eNB to RN;

c) Global eNB ID IE is constantly carried in eNB configuration update message. If global eNB ID IE is the same as global eNB ID of RN, RN judges it is the configuration information of DeNB, or it is the configuration information of DeNB neighbor eNB.

The format of ENB CONFIGURATION UPDATE message is specifically shown in FIG. 3,

TABLE 3

| IE/Group | | | IE type and | Semantics | | Assigned |
|---|---|---|---|---|---|---|
| Name | Presence | Range | reference | description | Criticality | Criticality |
| Message | M | | 9.2.13 | | YES | Reject |
| Type | | | | | | |
| Global eNB | O | | 9.2.22 | | YES | Ignore |
| ID | | | | | | |
| Served cells | | 0 to | | | GLOBAL | Reject |
| To Add | | maxCellineNB | | | | |
| >Served cell | M | | 9.2.8 | | — | — |
| Information | | | | | | |
| >Neighbour | | 0 to | | | — | — |
| Information | | maxnoofNeighbours | | | | |
| >>ECGI | M | | ECGI | E-UTRAN | — | — |
| | | | 9.2.14 | Cell Global | | |
| | | | | Identifier of | | |
| | | | | the neighbour | | |
| | | | | cell | | |
| >>PCI | M | | INTEGER | Physical Cell | — | — |
| | | | (0 . . . 503,) | Identifier of | | |
| | | | | the neighbour | | |
| | | | | cell | | |
| >>EARFCN | M | | 9.2.26 | DL EARFCN | — | — |
| | | | | for FDD and | | |
| | | | | EARFCN for | | |
| | | | | TDD | | |
| Served cells | | 0 to | | | GLOBAL | Reject |
| To Modify | | maxCellineNB | | | | |
| >Old | M | | ECGI | This is the old | — | — |
| ECGI | | | 9.2.14 | E-UTRAN | | |
| | | | | Cell Global | | |
| | | | | Identifier | | |
| >Served cell | M | | 9.2.8 | | — | — |
| Information | | | | | | |
| >Neighbour | | 0 to | | | — | — |
| Information | | maxnoofNeighbours | | | | |
| >>ECGI | M | | ECGI | E-UTRAN | — | — |
| | | | 9.2.14 | Cell Global | | |
| | | | | Identifier of | | |
| | | | | the neighbour | | |
| | | | | cell | | |
| >>PCI | M | | INTEGER | Physical Cell | — | — |
| | | | (0 . . . 503,) | Identifier of | | |
| | | | | the neighbour | | |
| | | | | cell | | |
| >>EARFCN | M | | 9.2.26 | DL EARFCN | — | — |
| | | | | for FDD and | | |
| | | | | EARFCN for | | |
| | | | | TDD | | |
| >Deactivation | O | | ENUMERATED | Indicates the | YES | Ignore |
| Indication | | | (deactivated, | concerned | | |
| | | | . . . ) | cell is | | |
| | | | | switched off | | |
| | | | | for energy | | |
| | | | | saving | | |
| | | | | reasons | | |
| Served cells | | 0 to | | | GLOBAL | Reject |
| To Delete | | maxCellineNB | | | | |
| >Old | M | | ECGI | This is the old | — | — |
| ECGI | | | 9.2.14 | E-UTRAN | | |
| | | | | Cell Global | | |
| | | | | Identifier of | | |
| | | | | the cell to be | | |
| | | | | deleted | | |
| GU Group | | 0 to | | | GLOBAL | Reject |
| Id To Add | | maxPools | | | | |
| List | | | | | | |
| >GU Group | M | | 9.2.20 | | — | — |
| Id | | | | | | |
| GU Group | | 0 to | | | GLOBAL | Reject |
| Id To | | maxPools | | | | |
| Delete List | | | | | | |
| >GU Group | M | | 9.2.20 | | — | — |
| Id | | | | | | |

### Embodiment VI

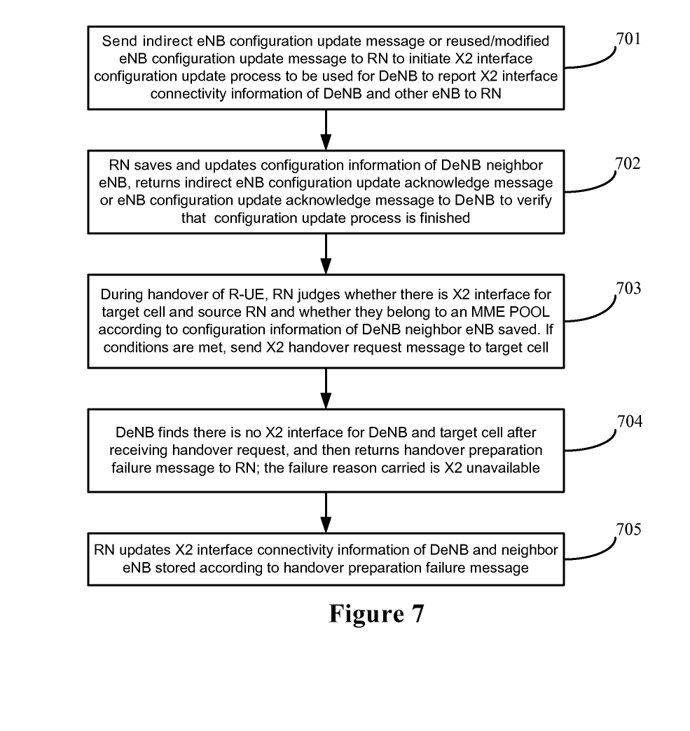

In Embodiments III-V of the present invention, RN can acquire X2 interface connectivity information of DeNB and other eNBs, but the occurrence of abnormal situation can not be excluded. For example, since DeNB reports information of a certain eNB having no X2 connection with DeNB to RN by mistake in indirect eNB configuration update message or reused/modified eNB configuration update message, or due to mistake judgment of RN handover, or owing to software operation, etc., handover failure may occur when RN initiates X2 handover to the eNB. Hence, in Embodiments VI of the present invention, RN knows the eNB having no X2 connection with DeNB by ways of carrying reason value: X2 not available in cause IE in handover preparation failure message returned by DeNB, as shown in FIG. 7, which includes the following steps:

Step 701, send indirect eNB configuration update or reused/modified eNB configuration update message to RN to initiate X2 interface configuration update process to be used for DeNB to report X2 interface connectivity information of DeNB and neighbor eNB to RN.

Step 702, RN saves and updates X2 interface connectivity information of DeNB and neighbor eNB, returns indirect eNB configuration update acknowledge or eNB configuration update acknowledge message to DeNB, and verifies that configuration update process is finished.

Step 703, during handover of R-UE, RN judges whether there is X2 interface for target cell and source RN and whether they belong to an MME POOL according to configuration information of DeNB neighbor eNB saved. If conditions are met, send X2 handover request message to target cell.

Step 704, DeNB finds out there is no X2 interface for DeNB and target cell after receiving handover request, and then returns handover preparation failure message to RN; the failure reason carried is X2 not available.

Step 705, RN updates X2 interface connectivity information of DeNB and neighbor eNB stored according to handover preparation failure message. For example, RN deletes the configuration information of neighbor eNB of DeNB in X2 interface connectivity information of DeNB and neighbor eNB with failure reason of X2 not available.

### Embodiment VII

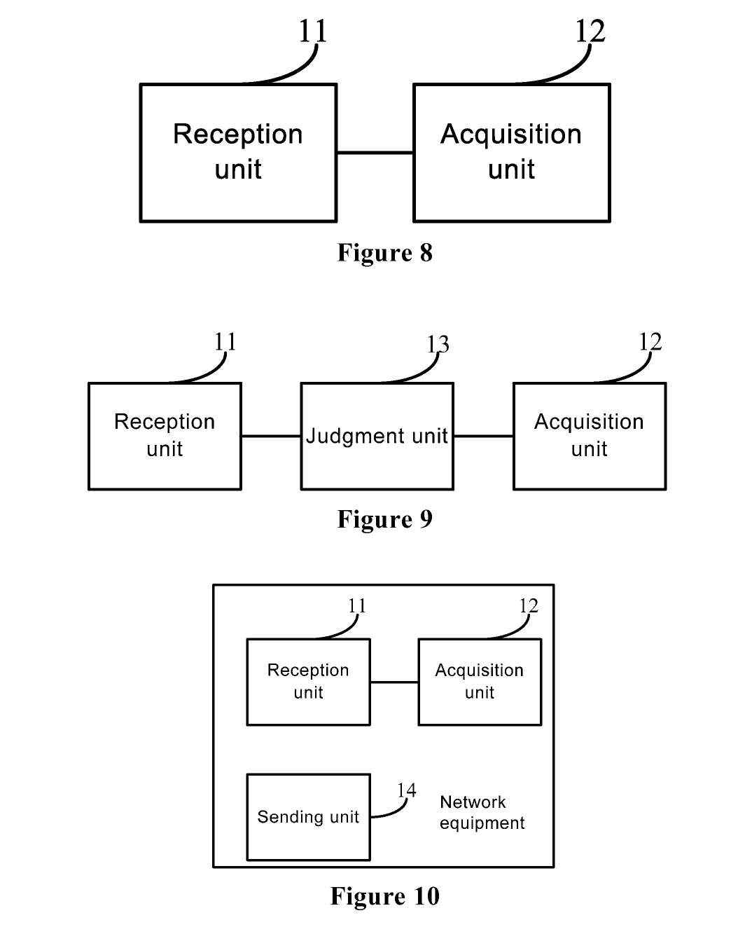

Embodiment VII of the present invention provides a network device, as shown in FIG. 8, including:

Reception unit 11, which is used to receive the message sent by eNB through X2 interface;

Acquisition unit 12, which is used to acquire interface connectivity information between said eNB and neighbor eNB carried in said message.

Said message is specifically eNB configuration update message, as shown in FIG. 9. The network device also includes judgment unit 13, which is used to:

Judge configuration information carried in said eNB configuration update message is the configuration information of neighbor eNB of said eNB or that of said eNB according to serving cell information carried in said eNB configuration update message; or,

Judge configuration information carried in said eNB configuration update message is the configuration information of neighbor eNB of said eNB or that of said eNB according to whether global eNB ID IE is carried in said eNB configuration update message; or,

Judge configuration information carried in said eNB configuration update message is the configuration information of neighbor eNB of said eNB or that of said eNB according to the global eNB ID IE carried in said eNB configuration update message.

Said message also can be indirect eNB configuration update message specifically; as shown in FIG. 10, the device also includes sending unit 14 that is used to send indirect eNB configuration update request message to said eNB.

Said interface connectivity information contains the following one or several kinds of information: ID of neighbor eNB having X2 interface with said eNB; serving cell configuration information of said neighbor eNB; serving cell configuration information added by said neighbor eNB; serving cell configuration information modified by said neighbor eNB; serving cell configuration information deleted by said neighbor eNB; neighbor cell configuration information of serving cell of said neighbor eNB; MME POOL information of said neighbor eNB; energy-saving status of serving cell of said neighbor eNB.

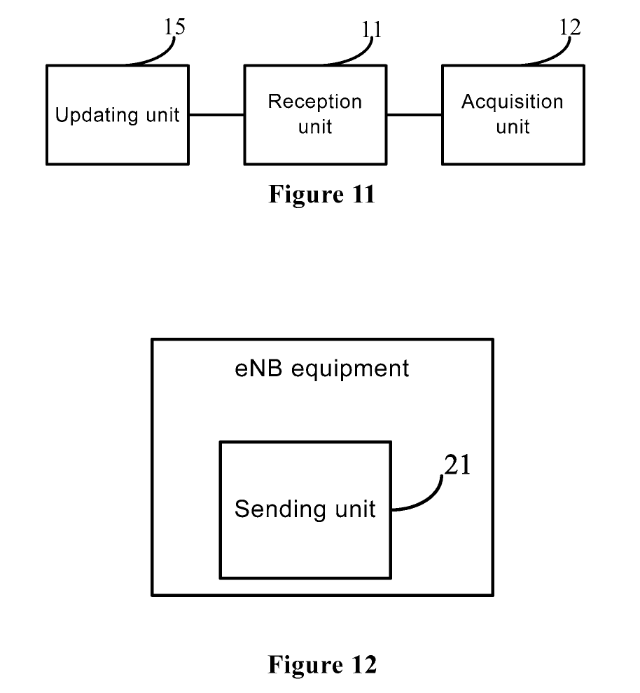

Said reception unit is also used to: receive handover preparation failure message sent by said eNB, as shown in FIG. 11. It also includes updating unit 15, which is used to update interface connectivity information between said eNB and neighbor eNB according to failure reason carried in said handover preparation failure message.

The network device is specifically relay node (RN).

### Embodiment VIII

Embodiment VIII of the present invention provides a kind of eNB, as shown in FIG. 12, including: Sending unit 21, which is used to send message through X2 interface, and such message carries the interface connectivity information between said eNB and neighbor eNB.

Said message is specifically eNB configuration update message. Said eNB configuration update message distinguishes the carried configuration information is that of neighbor eNB of said eNB or that of said eNB through the carried serving cell information; or said eNB configuration update message distinguishes the carried configuration information is that of neighbor eNB of said eNB or that of said eNB through whether it is carried with global eNB ID IE; or said eNB configuration update message distinguishes the carried configuration information is that of neighbor eNB of said eNB or that of said eNB through the carried global eNB ID IE.

Said message can also be indirect eNB configuration update information specifically.

Said interface connectivity information contains the following one or several kinds of information: ID of neighbor eNB having X2 interface with said eNB; serving cell configuration information of said neighbor eNB; serving cell configuration information added by said neighbor eNB; serving cell configuration information modified by said neighbor eNB; serving cell configuration information deleted by said neighbor eNB; neighbor cell configuration information of serving cell of said neighbor eNB; MME POOL information of said neighbor eNB; energy-saving status of serving cell of said neighbor eNB.

Said sending unit 21 is also used to send handover preparation failure message carrying failure reason.

### Embodiment IX

Embodiment IX of the present invention provides a network device, including:

eNB, which is used to send message through X2 interface, and such message carries interface connectivity information between said eNB and neighbor eNB;

Relay node (RN), which is used to receive the message sent by eNB through interface X2 and acquire interface connectivity information between said eNB and neighbor eNB carried in said message.

In embodiments of the present invention, eNB sends message carrying interface connectivity information between eNB and neighbor eNB through X2 interface to enable relay node to acquire the interface connectivity information between eNB and neighbor eNB to further accomplish handover, automatic neighbor relation setup, interference coordination and load equilibrium.

Through description of the above embodiments, technical personnel of the field can clearly understand that the present invention is realized depending on software and necessary general hardware platform, and also can be realized through hardware, while the former is better in many cases. Based on this understanding, the technical solution of the present invention or the part making contributions to available technology can be essentially reflected by means of software product. This computer software product is stored in a storage medium, including several instructions to enable a computer unit (such as personal computer, sever, or network device, etc.) to implement the methods described in all embodiments of the present invention.

Technical personnel of the field can understand that the drawings only refer to the diagram of a preferred embodiment, and the module or procedure attached is not indispensable for the implementation of the embodiments of the present invention.

Technical personnel of the field can understand that the module of the unit of an embodiment can be distributed in such unit according to embodiment description, or located in one or more units of another embodiment through corresponding changes. Modules of the embodiments mentioned above can be merged into one module, or further divided into multiple sub-modules.

The number of the aforementioned embodiments of the present invention is only used for description rather than representing advantages or disadvantages.

Only several specific embodiments of the present invention are released above. However, the present invention is not only comprised of those. Any change that technical personnel of the field can predict shall be protected by the present invention.

What is claimed is:

1. A method for receiving interface connectivity information the method comprising:
Receiving the message sent by eNB through X2 interface;
Acquiring interface connectivity information between said eNB and neighbor eNB carried in said message.

2. The method as claimed in claim 1, wherein said message is specifically eNB configuration update message.

3. The method as claimed in claim 2 further comprising the following before acquiring interface connectivity information between said eNB and neighbor eNB carried in said information:
acquiring serving cell information carried in configuration update message of said eNB, judging that configuration update message of said eNB caning configuration information of neighbor eNB of said eNB or configuration information of said eNB according to serving cell information; or
when configuration update message of said eNB caning global eNB ID IE, judging that configuration update message of said eNB carries configuration information of neighbor eNB of said eNB, otherwise, judging that configuration update message of said eNB carries configuration information of said eNB; or
acquiring global eNB ID IE carried in configuration update message of said eNB, judging that configuration update message of said eNB earring configuration information of neighbor eNB of said eNB or configuration information of said eNB according to global eNB ID IE.

4. The method as claimed in claim 1, wherein said message is specifically indirect eNB configuration update message.

5. The method as claimed in claim 4 further comprising the following before receiving message sent by eNB through X2 interface:
sending indirect eNB configuration update request message to said eNB.

6. The method as claimed in claim 1, wherein said interface connectivity information containing the following one or several kinds of information:
ID of neighbor eNB having X2 interface with said eNB; serving cell configuration information of said neighbor eNB; serving cell configuration information added by said neighbor eNB;
serving cell configuration information modified by said neighbor eNB; serving cell configuration information deleted by said neighbor eNB; neighbor cell configuration information of serving cell of said neighbor eNB; MME POOL information of said neighbor eNB; energy-saving status of serving cell of said neighbor eNB.

7. The method as claimed in claim 1 further comprising:
Acquiring failure reason carried thereof after receiving handover preparation failure message sent by said eNB to indicate nonexistence of X2 interface, update interface connectivity information between said eNB and neighbor eNB stored according to said failure reason.

8. A method for sending interface connectivity information further comprising:
eNB sending message through X2 interface, and such message carrying interface connectivity information between said eNB and neighbor eNB.

9. The method as claimed in claim 8, wherein said message is specifically eNB configuration update message.

10. The method as claimed in claim 9, wherein said eNB configuration update message distinguishing the carried configuration information is that of neighbor eNB of said eNB or that of said eNB through the carried serving cell information, or,
said eNB configuration update message distinguishing the carried configuration information is that of neighbor eNB of said eNB or that of said eNB through whether it is carried with global eNB ID IE, or,
said eNB configuration update message distinguishing the carried configuration information is that of neighbor eNB of said eNB or that of said eNB through the carried global eNB ID IE.

11. The method as claimed in claim 8, wherein said message is specifically indirect eNB configuration update message.

12. The method as claimed in claim 8, wherein said interface connectivity information containing the following one or several kinds of information:
ID of neighbor eNB having X2 interface with said eNB; serving cell configuration information of said neighbor eNB; serving cell configuration information added by said neighbor eNB;
serving cell configuration information modified by said neighbor eNB; serving cell configuration information deleted by said neighbor eNB; neighbor cell configuration information of serving cell of said neighbor eNB; MME POOL information of said neighbor eNB; energy-saving status of serving cell of said neighbor eNB.

13. The method as claimed in claim 8, further comprising:
said eNB indicates X2 interface does not exist in failure reason carried in handover preparation failure message.

14. A network device comprising:
reception unit, which is used to receive e the information sent by eNB through X2 interface;
acquisition unit, which is used to acquire interface connectivity information between said eNB and neighbor eNB carried in said information.

15. The network device as claimed in claim 14, wherein said message is specifically eNB configuration update message.

16. The network device as claimed in claim 15 further comprising a judgment unit, which is used to:
judge that configuration update message of said eNB carries configuration information of neighbor eNB of said eNB or configuration information of said eNB according to serving cell information carried in said eNB configuration update message; or,
judge that configuration update message of said eNB carries configuration information of neighbor eNB of said eNB or configuration information of said eNB according to whether global eNB ID IE is carried in said eNB configuration update message; or,
judge that configuration update message of said eNB carries configuration information of neighbor eNB of said eNB or configuration information of said eNB according to the global eNB ID IE carried in said eNB configuration update message.

17. The network device as claimed in claim 14, wherein said message is specifically indirect eNB configuration update message.

18. The network device as claimed in claim 17, further comprising:
sending unit, which is used to send indirect eNB configuration update request message to said eNB.

19. The network device as claimed in claim 14, wherein said interface connectivity information contains the following one or several kinds of information: ID of neighbor eNB having X2 interface with said eNB; serving cell configuration information of said neighbor eNB; serving cell configuration information added by said neighbor eNB; serving cell configuration information modified by said neighbor eNB; serving cell configuration information deleted by said neighbor eNB; neighbor cell configuration information of serving cell of said neighbor eNB; MME POOL information of said neighbor eNB; energy-saving status of serving cell of said neighbor eNB.

20. The network device as claimed in claim 14, wherein said reception unit is also used to receive handover preparation failure message sent by said eNB;
it also includes updating unit, which is used to update interface connectivity information between said eNB and neighbor eNB according to failure reason carried in said handover preparation failure message that indicates X2 interface does not exist.

21-47. (canceled)
